(19) United States
(12) Patent Application Publication
(10) Pub. No.: US 2006/0212874 A1
(43) Pub. Date: Sep. 21, 2006

(54) Inserting instructions

(76) Inventors: Erik J. Johnson, Hillsboro, OR (US); James L. Jason, Portland, OR (US); Harrick M. Vin, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/734,457

(22) Filed: Dec. 12, 2003

(51) Int. Cl. G06F 9/46

(52) U.S. Cl. 718/107

(57) ABSTRACT

In general, in one aspect, the disclosure describes a method of automatically inserting into a first thread instructions that relinquishes control of a multi-tasking processor to another thread will be concurrently sharing the processor.

### BACKGROUND

Originally, computer processors executed instructions of a single program, one instruction at a time, from start to finish. Many modern day systems continue to use this approach. However, it did not take long for the idea of multi-tasking to emerge. In multi-tasking, a single processor seemingly executes instructions of multiple programs simultaneously. In reality, the processor still only processes one instruction at a time but creates the illusion of simultaneity by interleaving execution of instructions from different programs. For example, a processor may execute a few instructions of one program then a few instructions of another.

One type of multi-tasking is known as “pre-emptive” multitasking. In pre-emptive multi-tasking, the processor makes sure that each program gets some processor time. For example, the processor may use a round-robin scheme to schedule each program with a slice of processor time in turn.

Another type of multi-tasking system is known as a “co-operative” multi-tasking system. In co-operative multi-tasking, the programs themselves relinquish control of the processor by including instructions that cause the processor to swap to another program. This scheme can be problematic if one program hoards the processor at the expense of other programs.

### BRIEF DESCRIPTION OF THE DRAWINGS

FIGS. 1A and 1B are diagrams illustrating execution of thread instructions.

FIG. 2 is a diagram illustrating insertion of an instruction to relinquish control of a processor.

FIGS. 3A-3D are diagrams illustrating insertion of relinquish instructions based on a data flow graph of a thread.

FIGS. 4A and 4C-4E are listings of pseudo-code to insert relinquish instructions.

FIG. 4B is a diagram illustrating determination of locations to insert relinquish instructions.

FIG. 5 is a flow chart of a process to insert relinquish instructions.

FIG. 6 is a diagram of a network processor.

### DETAILED DESCRIPTION

As described above, co-operative multi-tasking relies on software engineers to write programs that voluntarily surrender processor control to other programs. To comply, software engineers frequently write their programs to surrender processor control after instructions that will need some time to complete. For example, it may take some time before the results of an instruction specifying a memory access or Input/Output (I/O) operation are returned to the processor. Thus, instead of leaving the processor idle during these delays, programmers typically use these opportunities to share the processor with other programs.

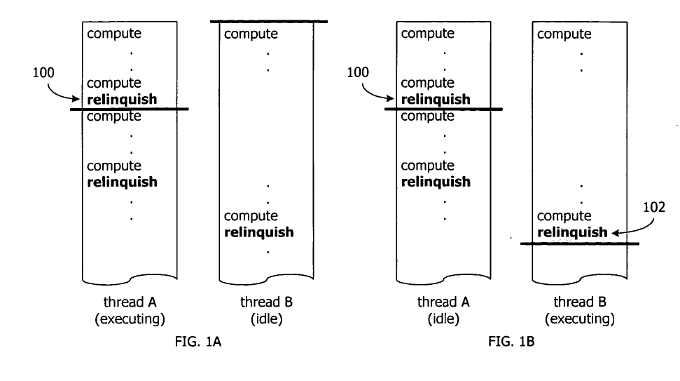

Potentially, one program may be written to frequently relinquish processor control while another may not. For example, one program making many I/O requests may frequently relinquish control while another program may include long uninterrupted series of computing instructions (i.e., instructions that do not relinquish control). As an example, FIGS. 1A and 1B illustrates execution of two programs known as threads. Each thread has its own independent flow of control though the threads can access some common resources such as memory.

In FIG. 1A, thread A controls the processor (shown as the shaded area) until reaching a relinquish instruction 100. In FIG. 1B, thread B then assumes control of the processor. Unlike thread A's comparatively brief execution period, thread B executes a very long sequence of instructions before encountering a relinquish instruction 102. As shown, thread B's hoarding may unfairly rob thread A of execution time to the detriment of overall system performance.

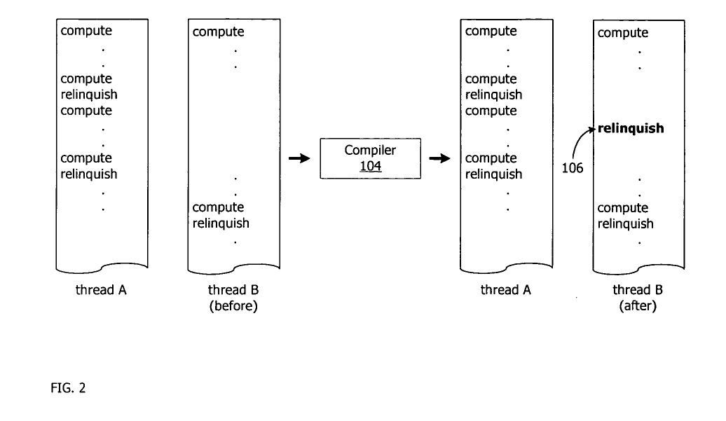

FIG. 2 illustrates operation of a scheme that effectively simulates pre-emptive multi-tasking without taxing the processor with the duty of enforcing fairness between the different programs being executed. Instead, a compiler 104 (or other program) automatically inserts instructions to relinquish control of a processor into the different programs. As shown in FIG. 2, after analyzing the instructions of thread A and thread B, the compiler 104 determines a location 106 within thread B's instructions to insert a relinquish instruction that will result in a fairer distribution of processor time between the threads. That is, the number of instructions executed before relinquishing control in both threads may be more uniform, or at least more controlled, after instruction insertion.

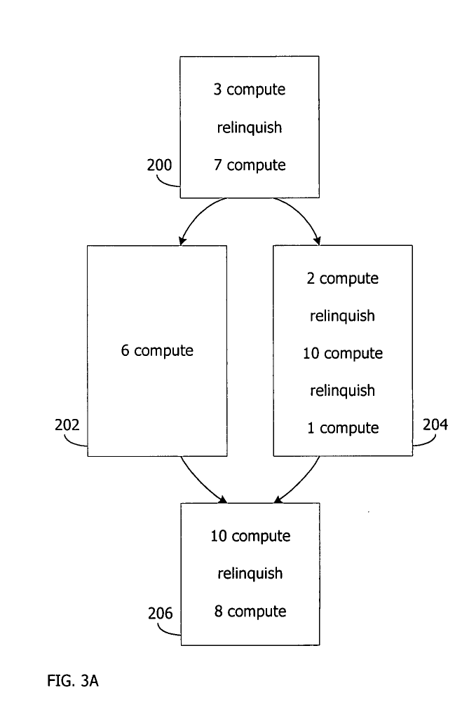

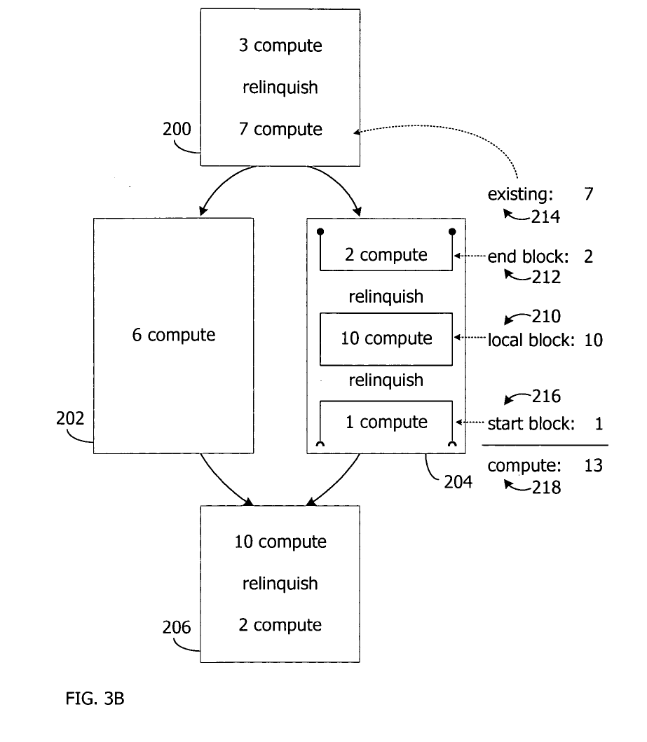

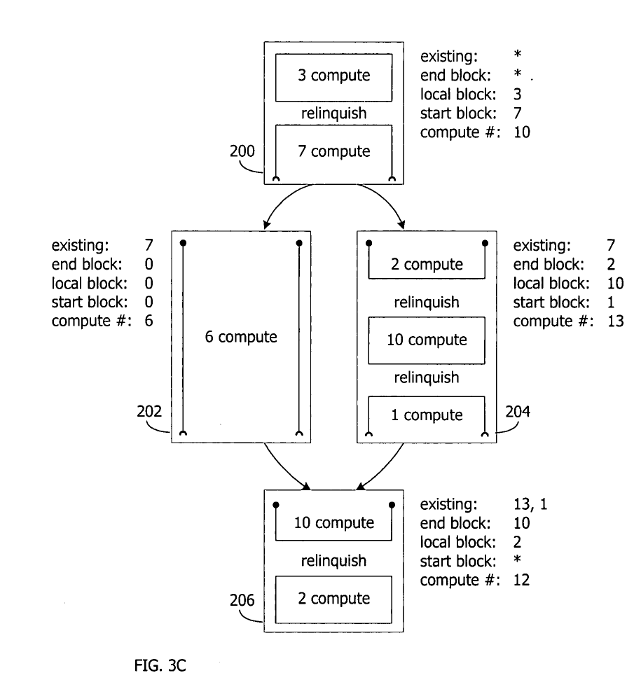

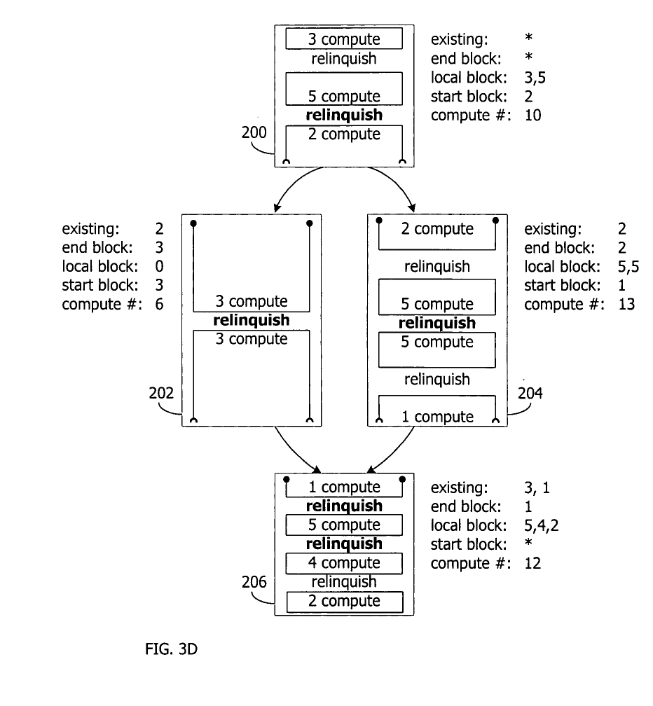

This automatic insertion of instructions may be implemented in a wide variety of ways. For example, FIGS. 3A-3D illustrate sample operation of a compiler that operates on a data flow graph of a program to break up large blocks of compute instructions into smaller ones. The data flow graph shown in FIG. 3A features an arrangement of nodes 200-206 representing potential execution flows of a program. For example, the first node 200 features a set of instructions that are always executed in the same unvarying sequence (known as a “basic block” in compiler terminology). Like most programs, the program represented in FIG. 3A includes instructions that perform conditional branching (e.g., “if x then y else z”). That is, in some situations instructions of node 200 will be followed by the instructions of node 202, but in other situations the instructions of node 200 will be followed by instructions of node 204. As shown in FIG. 3A, regardless of whether execution flows through node 202 or 204, both flows eventually reach node 206.

Based on the data flow graph, the compiler can identify different characteristics of each node. For example, in FIG. 3B the compiler has “annotated” node 204 to identify different blocks of consecutive compute instructions. For instance, the compiler identified a group of ten consecutive compute instructions sandwiched between two of the node's 204 relinquish instructions. This block of compute instructions completely internal to a node is labeled a “local block” 210. The compiler maintains a list of the lengths of all local blocks. Since node 204 only has one local block, its list only contains a single value.

In addition to local blocks 210, the compiler also determines information that can be used to identify blocks of consecutive compute instructions that span multiple nodes. For example, the compiler can identify, if present, a block of compute instructions that can terminate one or more compute blocks started in the node's ancestor(s). For example, the beginning of node 204 features 2-compute instructions followed by a relinquish instruction. Though potentially confusing, this beginning block of instructions is labeled an “end block” 212 since the block could end a block that started in an ancestor node. For example, the 2-compute instructions starting node 204 may form the end to a larger block of 9-compute instructions that began with the 7-compute instructions ending node 200.

As shown, the compiler's annotation for node 204 also includes the length of “existing” blocks 214 of compute instructions that started in the node's ancestor(s). Since node 204 only has a single ancestor (node 200), this information is a single value (i.e., the 7-compute instructions ending node 200). However, for nodes with multiple ancestors such as node 206, this information may be a list of different values corresponding to each different possible path of reaching the node that flows through unterminated compute blocks. Potentially, the “existing” blocks may span several generations of ancestors. For example, a value in the “existing” list for node 206 would include a value of 13 to reflect an uninterrupted skein of compute instructions starting in node 200 and continuing through node 202. The list would also include a value of 1 to reflect the 1-instruction “end block” of node 204.

Like its identification of an “end block” 212, the compiler also identifies compute instructions found at the end of a node that may represent the start of a new string of instructions terminated in some descendent(s). For example, node 204 ends with a single compute instruction that represents the start of a new block of compute instructions that terminates in node 206. The length of these ending instruction(s) is labeled as the “start block” 216 value.

As shown, the compiler annotation may include other information. For example, the compiler may determine the total 218 number of compute instructions in a given node.

As shown in FIG. 3C, the compiler can annotate each node 200-206 in the data flow graph. As shown, if program execution flows along nodes 200, 202, and 206, up to 23 consecutive compute instructions may be executed before processor control is relinquished (e.g., the 7 “start block” instructions of node 200+the 6 compute instructions of node 202+the 10 “end block” instructions of node 206). If, instead, program execution flows along nodes 200, 204, and 206, up to 11 consecutive compute instructions may be executed before control is relinquished (e.g., the 1 “end block” instruction of node 204+the 10 “start block” instructions of node 206). Though the later scenario is “friendlier” to other programs that may be vying for processor time, both possibilities may be unacceptably long.

FIG. 3D depicts the data flow graph after insertion of relinquish instructions, bolded, by the compiler. In this example, the compiler attempted to break the program data flow graph into compute blocks no larger than five consecutive instructions. After operation of the compiler, no matter which path execution flows through, the program will relinquish control after at most five consecutive instructions. For example, the compiler inserted an instruction into the 10 instruction “local block” of node 204 (FIG. 3C) to break it into two smaller local blocks (FIG. 3D) that are five instructions long. Due to the different execution flows and the different sizes of blocks, the resulting blocks vary in size.

Potentially, the compiler may leave stretches of compute instructions intact despite their excessive length. For example, some programs include sections of code, known as “critical sections”, that request temporary, uninterrupted control of the processor. For example, a thread may need to prevent other threads from accessing a shared routing table while the thread updates the routing table's values. Such sections are usually identified by instructions identifying the start end of the section of indivisible instructions (e.g., critical section “entry” and “exit” instructions). While the compiler may respect these declarations by not inserting relinquish instructions into critical sections, the compiler may nevertheless do some accounting reflecting their usage. For example, the compiler may automatically sandwich critical sections exceeding some length between relinquish instructions.

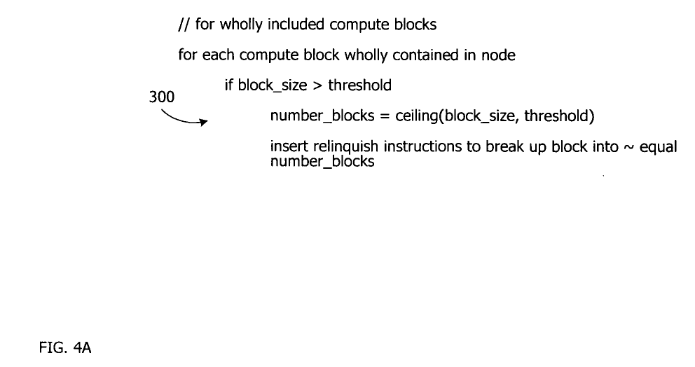

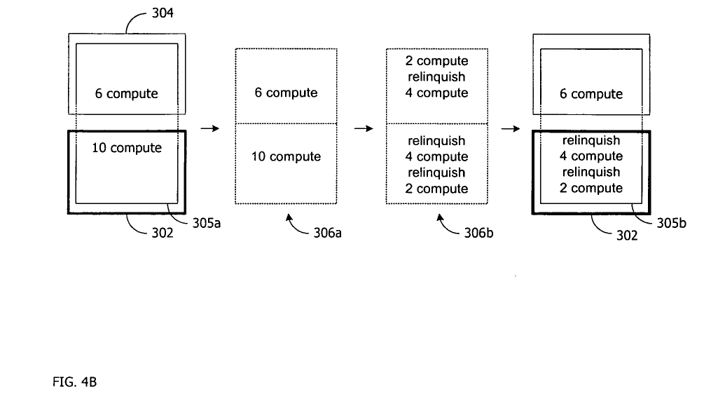

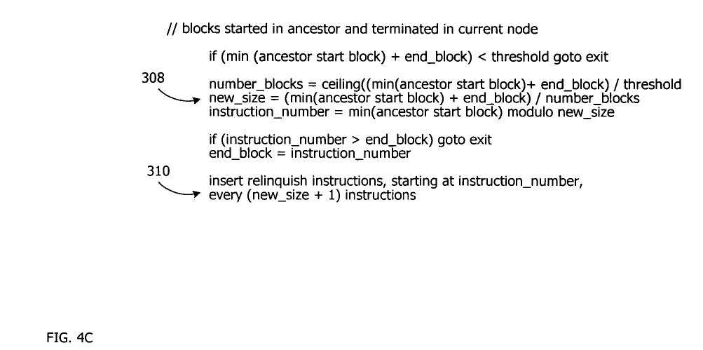

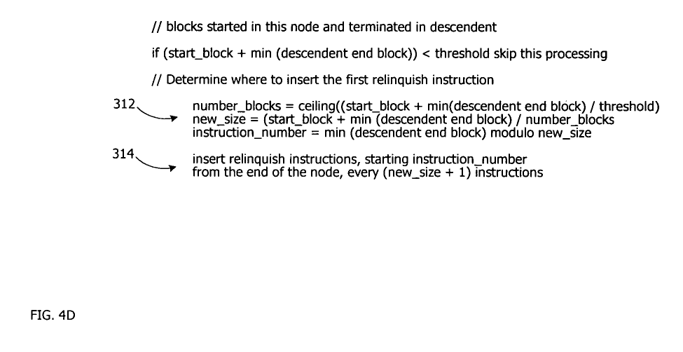

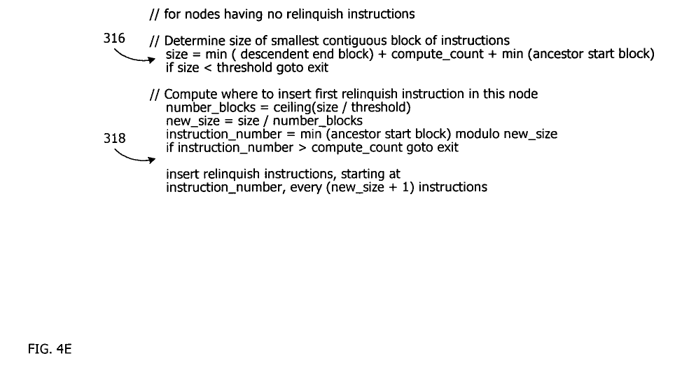

FIGS. 4A and 4B-4D show sample listings of “pseudo-code” that may perform the instruction insertion operations illustrated above. The code shown operates on a threshold value that identifies the maximum number of consecutive compute instructions the resulting code should have, barring exceptions such as critical sections. The compiler operates on each node using a recursive “bottom-up” approach. That is, each descendent node is processed before its ancestor(s).

The code listed in FIG. 4A handles “local blocks” wholly included within a node. The code divides 300 each such block into smaller, approximately equal sub-blocks separated by inserted relinquish instructions. The sub-blocks have a length that is less than or equal to the threshold length. The division may not be perfect, for example, if the block originally includes a number of instructions that are not an integral multiple of the threshold.

As described above, compute blocks may span multiple nodes. The code handles node-spanning spanning blocks by determining where the relinquish instructions could be inserted into the node-spanning block as a whole. For example, as shown in FIG. 4B, a block spanning nodes 304 and 302 includes 6 “existing” compute instructions of node 304 and a 10 instruction “end block” 305a of node 302. The relinquish instructions could be inserted into block 306a as shown in 306b to conform to a 5-instruction threshold. However, since the procedure operates on one node at a time, the code only modifies the instructions of node 302. Later, the procedure will operate on the instructions of node 304.

FIGS. 4C-4E list sample pseudo-code handling blocks that straddle nodes. In particular, the code listed in FIG. 4C handles an “end block” of compute instructions that may begin a node. Again, potentially, a node's “end block” may terminate existing compute blocks of many different ancestor nodes. As shown, the code operates 308 on the smallest “existing” compute block inherited from the node's ancestor(s). This ensures that even the smallest node spanning blocks are broken up if they exceed the threshold length. The code then determines 310 insertion locations and inserts the relinquish instructions as illustrated in FIG. 4B.

FIG. 4D depicts a similar operation that occurs for “start blocks”. Similar to the code that handled “end blocks”, the code determines the location(s) to insert 312 relinquish instructions based on a block formed by the node's “start block” and the smallest “end block” of the node's descendent(s). Based on this information, the “start block” code inserts 314 relinquish instructions in the “start block” node to break the “start block” into, at most, threshold length sub-blocks.

FIG. 4E lists code used to sub-divide instruction blocks in a node that does not include any relinquish instructions. In this case, the code determines locations to insert relinquish instructions based on a block formed by combining 316 the node with the smallest existing and ending compute instructions of ancestor and descendent nodes, respectively. Based on this information, relinquish instructions are inserted 318 into the node's set of instructions where such instructions would divide the block into sub-blocks smaller than the threshold length.

The sample operations illustrated in FIGS. 3A-3D and the code listed in FIGS. 4A and 4C-4E applied a threshold to the instructions of a thread represented by a data flow graph. However, applying this threshold to one of these threads alone does not ensure fairness (e.g., equal distribution of processor execution). That is, if compute blocks of only one thread were broken up, other threads having fewer relinquish instructions may soon dominate the processor. Thus, to achieve fairness, however defined, the procedure should be applied to multiple threads that will operate on the same processor.

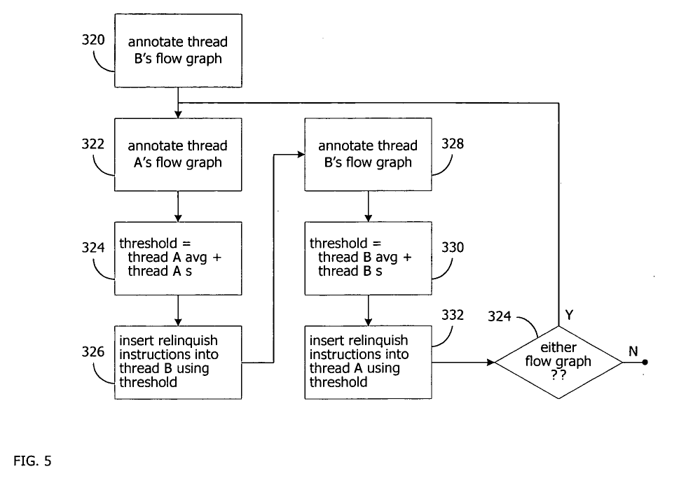

For example, FIG. 5 depicts an example of a process to insert relinquish instructions into two threads, A and B, to be executed by the same processor. As shown, after annotation of the threads' data flow graphs 320, 322, the process determines 324, 330 a threshold to apply 326, 332 to one thread based on analysis of the other. As an example, if compute blocks in thread A have an average length of N-instructions, a fair allocation of the processor may limit the blocks of thread B to this length. Instead of simply using the average, however, the threshold may be determined as the sum of a thread's average compute block length and the standard deviation of the lengths. The standard deviation provides a measure of fairness. The smaller the standard deviation the more balanced the final set of tasks will be. As an example, the data flow graph shown in FIG. 3A features compute blocks of 3, 23, and 2 along the path tracing through nodes 200, 202, and 206. The path flowing through nodes 200, 204, and 206 features compute blocks of 3, 9, 10, 11, and 2. Statistically, the unique compute blocks between the two paths yield an average of 9-instructions-per-compute-block with a standard deviation of ˜7. Thus, a threshold of 16 may be applied to a different thread that will execute on the same processor.

A first application 326, 332 of this instruction insertion procedure to both threads may affect one thread more than another. This may result in an improved but still unbalanced distribution of processor time between threads. Thus, as shown, the operations repeat until 324 both threads are left unchanged by an iteration. In other words, both thread's compute blocks are repeatedly sub-divided until they converge on a solution that is not improved upon.

Ultimately, the iterative approach of FIG. 5 roughly shares the processor between the two threads. This approach may also be used on multiple threads instead of just the two shown. The process may be altered to give one thread greater use of the processor, for example, by altering the threshold applied to that thread. For example, a thread performing time-critical operations (e.g., data plane packet processing) may justifiably consume more processing time than a thread that performs operations that can be deferred (e.g., control plane packet processing). Thus, the threshold applied to the time-critical thread may be some multiple of the threshold applied to less important threads. Additionally, an alternate approach may simply perform a one-pass application of some constant threshold to all threads. This alternate approach may minimize swapping between threads which consumes a small, but existent, amount of time. Again, a wide variety of different implementations are possible.

The approach illustrated above may be used to process instructions for wide variety of multi-threaded devices such as a central processing unit (CPU). The approach may also be used to process instructions for a device including multiple processors. As an example, the techniques may be implemented within a development tool for Intel's(r) Internet eXchange network Processor (IXP).

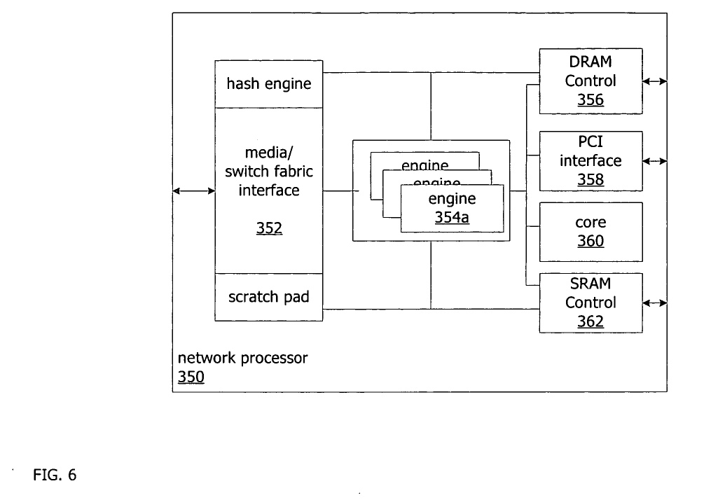

FIG. 6 illustrates the architecture of a multi-engine network processor 350 that includes a collection of engines 354 integrated on a single semiconductor chip. The collection of engines 354 can be programmed to process packets in parallel. For example, while one engine thread processes one packet, another thread processes another. This parallelism enables the network processor 350 to keep apace the rapid arrival of network packets that would otherwise exceed the capability of any one engine alone. The engines 354 may be Reduced Instruction Set Computing (RISC) processors tailored for packet processing operations. For example, the engines 354 may not include floating point instructions or instructions for integer multiplication or division commonly provided by general purpose processors.

Each engine 354 can provide multiple threads. For example, a multi-threading capability of the engines 354 may be supported by hardware that reserves different registers for different threads and can quickly swap thread execution contexts (e.g., program counter and other execution register values).

An engine 354 may feature local memory that can be accessed by threads executing on the engine 354. The network processor 350 may also feature different kinds of memory shared by the different engines 354. For example, the shared “scratchpad” provides the engines with fast on-chip memory. The processor also includes controllers 362, 356 to external Static Random Access Memory (SRAM) and higher-latency Dynamic Random Access Memory (DRAM).

The engines may feature an instruction set that includes instructions to relinquish processor control. For example, an engine “ctx_arb” instruction instructs the engine to immediately swap to another thread. The engine also includes instructions that can combine a request to swap threads with another operation. For example, many instructions for memory accesses such as “sram” and “dram” instructions can specify a “ctx_swap” parameter that initiates a context swap after the memory access request is initiated.

As shown, the network processor 350 features other components including a single-threaded general purpose processor 360 (e.g., a StrongARM(r) XScale(r)). The processor 350 also includes interfaces 352 that can carry packets between the processor 350 and other network components. For example, the processor 350 can feature a switch fabric interface 352 (e.g., a CSIX interface) that enables the processor 350 to transmit a packet to other processor(s) or circuitry connected to the fabric. The processor 350 can also feature an interface 352 (e.g., a System Packet Interface Level 4 (SPI-4) interface) that enables to the processor 350 to communicate with physical layer (PHY) and/or link layer devices. The processor 350 also includes an interface 358 (e.g., a Peripheral Component Interconnect (PCI) bus interface) for communicating, for example, with a host.

As described above, the techniques may be implemented by a compiler. In addition to the operations described above, the compiler may perform other compiler operations such as lexical analysis to group the text characters of source code into “tokens”, syntax analysis that groups the tokens into grammatical phrases, semantic analysis that can check for source code errors, intermediate code generation that more abstractly represents the source code, and optimizations to improve the performance of the resulting code. The compiler may compile an object-oriented or procedural language such as a language that can be expressed in a Backus-Naur Form (BNF). Alternately, the techniques may be implemented by other development tools such as an assembler, profiler, or source code pre-processor.

The instructions inserted may be associated with different levels of source code depending on the implementation. For example, an instruction inserted may be an instruction within a high-level (e.g., a C-like language) or a lower-level language (e.g., assembly).

Though most useful in a co-operative multi-tasking system, the approach described above may also be used in a pre-emptive multi-tasking system to alter the default swapping provided in such a system.

Other embodiments are within the scope of the following claims.

What is claimed is:

1. A method, comprising:
automatically inserting into instructions of a first thread at least one instruction that relinquishes control of a multi-tasking processor to another thread that will be concurrently sharing the processor.

2. The method of claim 1, further comprising:
automatically inserting into instructions of a second thread at least one instruction that relinquishes control of the multi-tasking processor to another thread that will be concurrently sharing the processor.

3. The method of claim 2, wherein
automatically inserting into instructions of the first thread comprises inserting based on at least one characteristic of the instructions of the second thread; and
automatically inserting into instructions of the second thread comprises inserting based on at least one characteristic of the instructions of the first thread.

4. The method of claim 2, further comprising:
repeating a procedure that determines one or more locations to automatically insert instructions that relinquish control of the processor into the instructions of the first and second threads.

5. The method of claim 3,
wherein the at least one characteristic of the instructions of the first thread comprises an average number of consecutive instructions that do not relinquish control of the processor.

6. The method of claim 5,
wherein the at least one characteristic of the instructions of the first thread comprises a standard deviation derived from the number of consecutive instructions that do not relinquish control of the processor.

7. The method of claim 1, further comprising:
constructing a data flow graph of the instructions of the first thread, the data flow graph comprising an organization of nodes associated with subsets of the instructions of the first thread; and
determining at least one of the following:
a number of consecutive instructions ending a one of the nodes that do not relinquish control of the processor;
a number of consecutive instructions beginning a one of the nodes that do not relinquish control of the processor; and
a number of consecutive instructions between instructions of one of the nodes that relinquish control of the processor.

8. The method of claim 1, wherein automatically inserting comprises inserting to keep intact a group of instructions identified as indivisible.

9. The method of claim 1, wherein the processor comprises a multi-threaded central processor unit (CPU).

10. The method of claim 1, wherein the processor comprises a multi-threaded engine of a multi-engine processor.

11. The method of claim 10, wherein the multi-threaded engine of the multi-engine processor comprises an engine not having any floating point instructions in the engine's instruction set.

12. A computer program product, disposed on a computer readable medium, the program including instructions to:
access instructions of a first thread; and
insert into the instructions of a first thread at least one instruction that relinquishes control of a multi-tasking processor to another thread that will be concurrently sharing the processor.

13. The program of claim 12, further comprising instructions to:
insert into instructions of a second thread at least one instruction that relinquishes control of the processor.

14. The program of claim 13, wherein the instructions to:
insert into instructions of the first thread comprises inserting based on at least one characteristic of the instructions of the second thread; and
insert into instructions of the second thread comprises inserting based on at least one characteristic of the instructions of the first thread.

15. The program of claim 13, further comprising instructions to:
repeat a procedure that determines one or more locations to automatically insert instructions that relinquish control of the processor into the instructions of the first and second threads.

16. The program of claim 14,
wherein the at least one characteristic of the instructions of the first thread comprises an average number of consecutive instructions that do not relinquish control of the processor.

17. The program of claim 16,
wherein the at least one characteristic of the instructions of the first thread comprises a standard deviation derived from the number of consecutive instructions that do not relinquish control of the processor.

18. The program of claim 1, further comprising instructions to:
construct a data flow graph of the instructions of the first thread, the data flow graph comprising an organization of nodes associated with subsets of the instructions of the first thread; and
determine at least one of the following:
a number of consecutive instructions ending a one of the nodes that do not relinquish control of the processor;
a number of consecutive instructions beginning a one of the nodes that do not relinquish control of the processor; and
a number of consecutive instructions between instructions of one of the nodes that relinquish control of the processor.

19. The program of claim 12, wherein the instructions to insert comprise instructions to insert to keep intact a group of instructions identified as indivisible.

20. The program of claim 12, wherein the processor comprises a multi-threaded central processor unit (CPU).

21. The program of claim 12, wherein the processor comprises a multi-threaded engine of a multi-engine processor.

22. The program of claim 21, wherein the multi-threaded engine of the multi-engine processor comprises an engine not having any floating point instructions in the engine's instruction set.

23. The program of claim 22, wherein the program comprises at least one of the following: a compiler, an assembler, and a source code pre-processor.

24. A method comprising:
managing execution control of a multi-tasking processor shared by multiple threads by automatically inserting instructions into at least some of the multiple threads to relinquish control of the multi-tasking processor to a different thread.

25. The method of claim 24, wherein managing comprises inserting instructions into the threads to provide a more equal distribution of processor execution control among at least some of the threads than before the inserting.

26. The method of claim 24, wherein managing comprises inserting instructions into the threads to provide a subset of the multiple threads a greater share of processor execution control than before the inserting.

27. The method of claim 24, wherein the inserting comprises inserting based on data flow graphs generated for the, respective, threads.

28. The method of claim 24, wherein the multi-tasking processor comprises a co-operative multi-tasking processor.

29. The method of claim 24, wherein the multi-tasking processor comprises a one of a set of multi-tasking processors integrated on the same semiconductor chip.
